(19) United States
(12) Patent Application Publication
(10) Pub. No.: US 2006/0259668 A1
(43) Pub. Date: Nov. 16, 2006

(54) System for managing sound input/output and method for the same

(76) Inventors: Hung-Peng Kang, Sindian City (TW); Chia-Chen Chen, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,213

(22) Filed: May 10, 2005

(51) Int. Cl. G06F 13/12

(52) U.S. Cl. 710/68

(57) ABSTRACT

A system for managing a sound input/output and a method for the same are proposed in the present invention. The present invention is used to remove the inconvenience and trouble caused by management and selection of sound devices. A sound device having an identification key is used to drive an integrated sound input/output managing program of a host computer. The system can be used to manage the operation of at least a sound device of the host computer.

### BACKGROUND OF THE INVENTION

1. Field of the Invention

The present invention is related to a system for managing a sound input/output and a method for the same, and more particularly, to a system that uses a sound device having an identification key to drive an integrated sound input/output managing program of a host computer. The system can thus be used to manage the operation of a sound device at least.

2. Description of Related Art

In general, most host computers are equipped with a sound device, such as a sound card. Thus, a video program, such as Real-player or Media player, or a real-time communication program, such as MSN or Skype, can be executed on the host computer for recording or playback of sound signals. Since more and more multimedia application programs are available and used, the integration of sound devices with a host computer is of great interest. In addition, the expansion capability of a host computer is more and more powerful. For example, various high-speed interfaces, such as USB and IEEE 1394 are used as mainstream interfaces between a host computer and a variety of peripheral devices.

The functionality of a host computer is greatly improved with a rapid increase of a CPU's operative speed. Hence, the host computer can process multiple application programs simultaneously without crash or operative lag. When the host computer processes multiple application programs that need to cooperate with a sound device, such as playing a video film and executing a real-time communication program at the same time, the host computer usually uses a predetermined sound device to perform the sound input/output operation. Thus, all the application programs need to use the same predetermined sound device. Changing the predetermined sound device of the programs requires individually changing the setting of the programs. For example, when a user uses two different communication programs at the same time, he needs to change the setting to make the two communication programs operate with different sound devices. Otherwise, the two communication programs will use the same sound device. As more application programs, such as programs for I-phone, relating to sound devices are developed and used, setting or usage of sound devices becomes inconvenient.

### SUMMARY OF THE INVENTION

An objective of the present invention is proposed for greater convenience and ease of management and selection of sound devices. For this sake, the present invention provides a system for managing a sound input/output and a method for the same. A sound device having an identification key is used to drive an integrated sound input/output managing program of a host computer. The system can be used to manage the operation of at least a sound device of the host computer.

For reaching the objective above, the present invention provides a system for managing a sound input/output. It includes a host computer and a sound device having an identification key. The host computer at least consists of a central processing unit (CPU) and a peripheral managing unit. The host computer uses the CPU to process and control input/output signals and the peripheral managing unit to manage the host computer's input/output signals. The sound device having the identification key consists of a sound processing unit and an interface control unit. The sound device having the identification key has a USB interface or an IEEE 1394 interface, and the identification key is stored in the sound device. The interface control unit is connected electrically to the sound processing unit and the host computer, respectively, and used to control the input/output signals transferred between the host computer and the sound device having the identification key. A display device is connected electrically to the host computer to show an operative condition of at least a sound device connected to the host computer. The system for managing the sound input/output further has at least a sound device connected electrically to the host computer. The host computer has at least a built-in sound device. As mentioned above, a user can uses an integrated sound input/output managing program to manage an operation of at least a sound device of the host computer. The integrated sound input/output managing program is active only after being driven by the sound device having the identification key.

The method of the present invention for managing the sound input/output includes: connecting a sound device having an identification key with a host computer; identifying the identification key of the sound device; driving an integrated sound input/output managing program if the identification is succeeded; and using the integrated sound input/output managing program to control at least a sound device of the host computer. The step of using the integrated sound input/output managing program to control the sound device of the host computer further includes: executing the integrated sound input/output managing program installed on the host computer; checking if an activating action of the integrated sound input/output managing program is completed; loading a setting file in the host computer if the activating action is successfully performed and showing original sound input/output settings of the host computer and at least a specific application program; a user being able to select the specific application program's sound device; and finally, ending the integrated sound input/output managing program and store the setting file. There are two embodiments. In the first embodiment, the sound device having the identification key is connected externally to the host computer. In the second embodiment, the host computer doesn't have a new sound device connected thereto.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a system for managing sound input/output in accordance with the present invention;

FIG. 2 is a schematic diagram of a graphical interface of the integrated sound input/output managing program in accordance with the present invention;

FIG. 3 is a flow chart of the first embodiment of a sound input/output managing method in accordance with the present invention;

FIG. 4 is a flow chart of the second embodiment of a sound input/output managing method in accordance with the present invention; and

FIG. 5 is a flow chart of the third embodiment of a sound input/output managing method in accordance with the present invention.

### DETAILED DESCRIPTION OF PREFERRED EMBODIMENTS

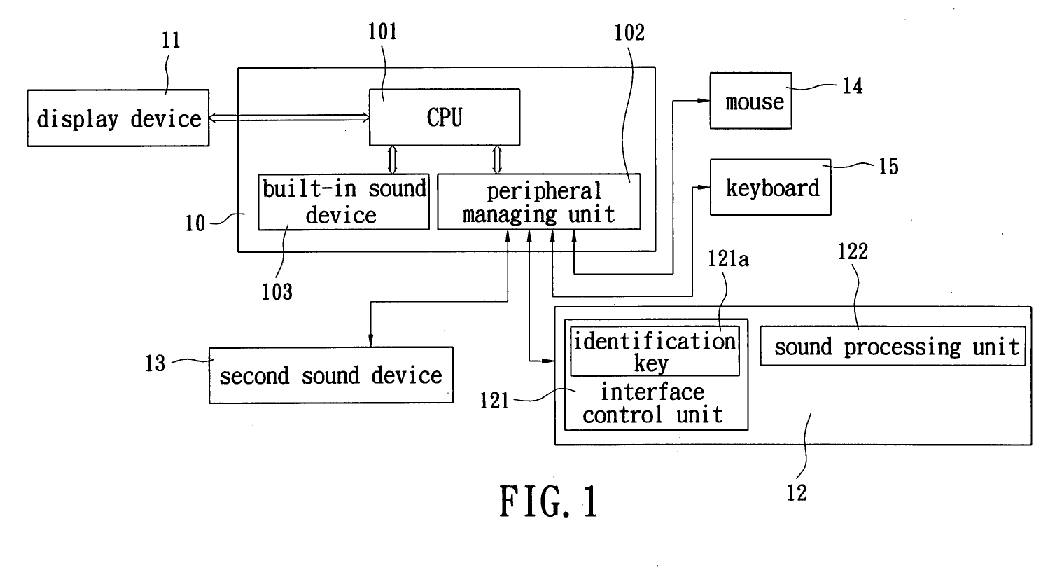

Reference is made to FIG. 1, which is a schematic diagram of a system for managing sound input/output in accordance with the present invention. The system includes a host computer 10, a sound device 12 having an identification key and a display device 11. The host computer 10 uses a central processing unit (CPU) 101 to process and control signals and a peripheral managing unit 102 to manage input/output signals. The host computer 10 is a computer system. In general, the host computer 10 has a built-in sound device 103.

The sound device 12 has at least a sound processing unit 122 and an interface control unit 121. The interface control unit 121 is connected electrically to the host computer 10 to control the input/output signals transferred between the host computer 10 and the sound device 12. The interface control unit 121 has an identification key 121a stored therein. The host computer 10 has a public program for identifying the identification key 121a. The sound processing unit 122 is connected electrically to the interface control unit 121 for conversion or compression of signals transferred between the host computer 10 and the sound device 12. Thus, the playback or recording or the sound signals of the host computer 10 and users can be performed.

After the host computer 10 identifies the identification key 121a of the sound device 12, a user can use an integrated sound input/output managing program of the host computer 10 to manage at least a sound device, such as the built-in sound device 103 or the sound device 12. The integrated sound input/output managing program can be used only after being identified and driven by the sound device 12. The sound device 12 can be a USB interface or an IEEE 1394 interface. The system of the present invention can further include a second sound device 13 connected electrically to the host computer 10. A display device 11 is connected electrically to the host computer 10 to show the operative statuses of the built-in sound device 103, the sound device 12 and the second sound device 13.

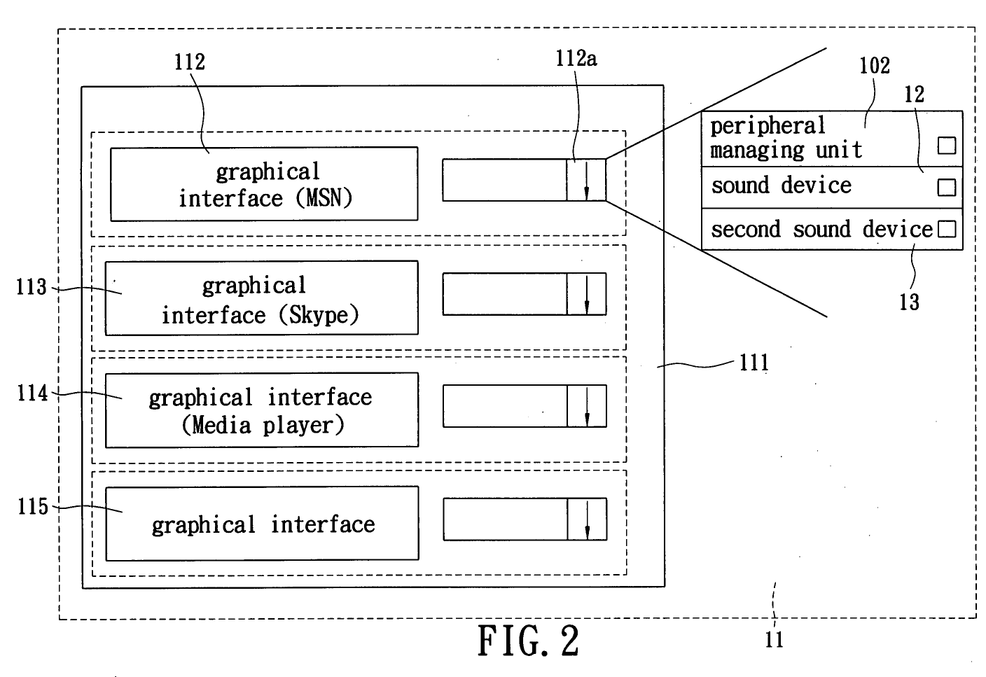

Reference is made to FIG. 1 together with FIG. 2, which is a schematic diagram of a graphical interface of the integrated sound input/output managing program in accordance with the present invention. After the sound device 12 is connected to the host computer 10, a user can activate the integrated sound input/output managing program. Then, the display device 11 shows a graphical interface 111. A user can uses the graphical interface 111 to change the setting of multiple specific application programs or other application programs of the system that need to function with a sound device. The specific application program can be a communication application program, such as an MSN program, a Yahoo program or a Skype program, or a video playback application program.

Thus, a user can see the graphical interface 111 used for managing sound input/output. The graphical interface 111 includes a graphical interface 112 of a first specific application program, a graphical interface 113 of a second specific application program, a graphical interface 114 of a third specific application program and a graphical interface 115 of other application programs of the system. Via the graphical interface 111, the user can make each of the specific application programs build a connection to any one of the sound devices connected electrically to the host computer 10.

For example, a graphical interface 112a for selecting the sound devices located beside the graphical interface 112 of the first specific application program can be used to select the built-in sound device 103, the sound device 12 or the second sound device 13, which is connected to the host computer 10, as the sound input/output device of the first specific application program.

In practical operation of the present invention, as an example, the built-in sound device 103 is used to play video file, the sound device 12 is used for an I-phone program and the second sound device 13 is used for recording sound signals at the same time.

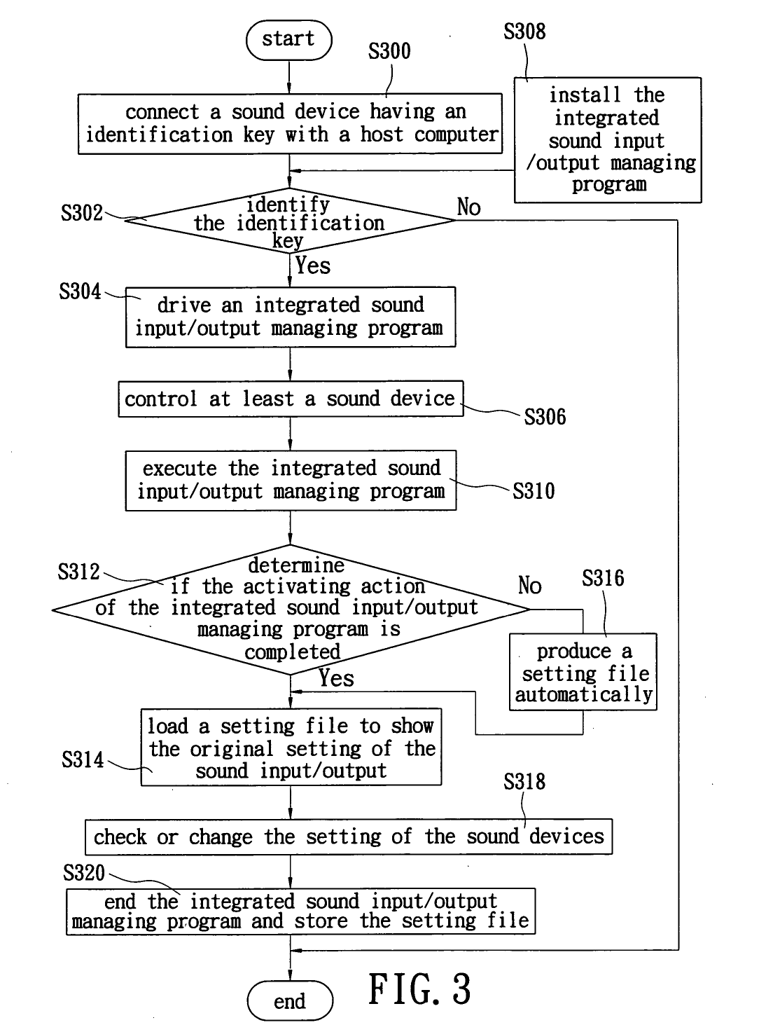

Reference is made to FIG. 3 together with FIGS. 1-2. FIG. 3 is a flow chart of the first embodiment of a sound input/output managing method in accordance with the present invention. The method include following steps. First, a user connects a sound device 12, which has an identification key, with a host computer 10 (step S300). Then, the host computer 10 identifies the identification key 121a of the sound device 12 (step S302). If the identification action succeeds, the sound device 12 drives an integrated sound input/output managing program of a host computer 10 (step S304). If the identification action fails, all of the processes of the present invention are ended. Subsequently, the integrated sound input/output managing program is used to control at least a sound device of the host computer 10 (step S306). Before or after step S300, the present invention can further includes a step for installing the integrated sound input/output managing program onto the host computer 10 (step S308).

Step S306 further includes following steps. First, the integrated sound input/output managing program of the host computer 10 is activated (step S310). Then, the present invention makes sure if the activating action of the integrated sound input/output managing program is completed (step S312). If the activating action is completed, a setting file is loaded into the host computer 10 to show the original setting of the sound input/output of at least a specific application program (step S314). If the activating action fails to be completed, the integrated sound input/output managing program produces a setting file automatically to initialize the host computer 10 and make at least an application program use the sound device 12 as the predetermined device to input/output sound signals (step S316). After that, step S314 is performed. Subsequently, by using the display device 11, a user can check or change the setting about the sound input/output devices of other application programs and at least a specific application program (step S318). Finally, the user can terminate the integrated sound input/output managing program and store the setting file (step S320). The specific application program can be a communication application program, such as an MSN program, a Yahoo program or a Skype program, or a video playback program.

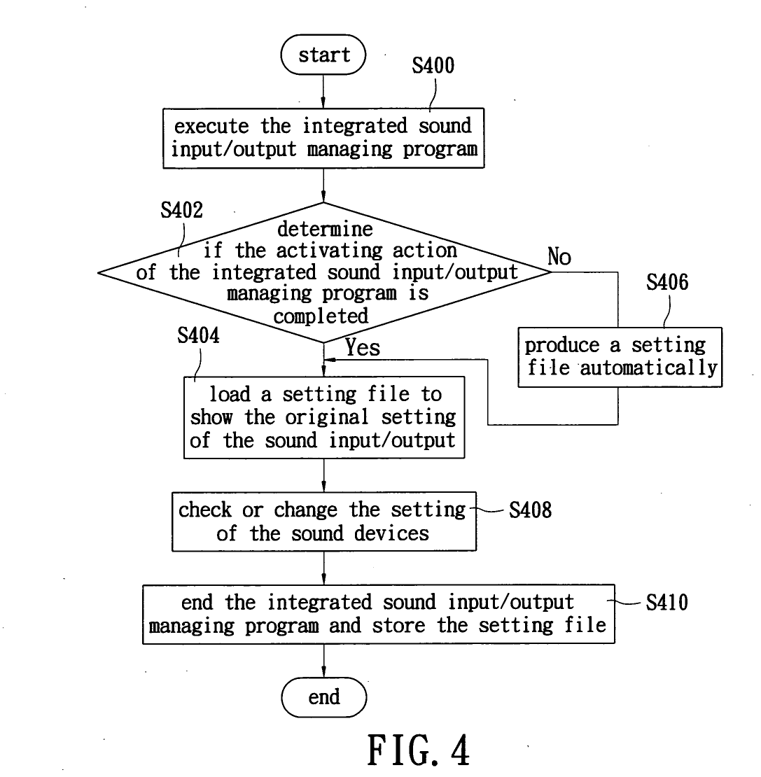

Reference is made to FIG. 4 together with FIG. 1. FIG. 4 is a flow chart of the second embodiment of a sound input/output managing method in accordance with the present invention. After the sound device 12, which has an identification key, is connected with the host computer 10, the host computer 10 is also connected electrically with a second sound device 13. As shown in FIG. 4, the method of the present invention includes following steps. First, the integrated sound input/output managing program of the host computer 10 is activated (step S400). Then, the present invention confirms if the activating action of the integrated sound input/output managing program is completed (step S402). If the activating action is completed, a setting file is loaded into the host computer 10 to show the original setting of the sound input/output of at least a specific application program (step S404). If the activating action fails to be completed, the integrated sound input/output managing program produces a setting file automatically to initialize the host computer 10 and make at least an application program use the sound device 12 as the predetermined device to input/output sound signals (step S406). After that, step S404 is performed. Subsequently, by using the display device 11, a user can check or change the setting about the sound input/output devices of other application programs and at least a specific application program (step S408). Finally, the user can terminate the integrated sound input/output managing program and store the setting file (step S410).

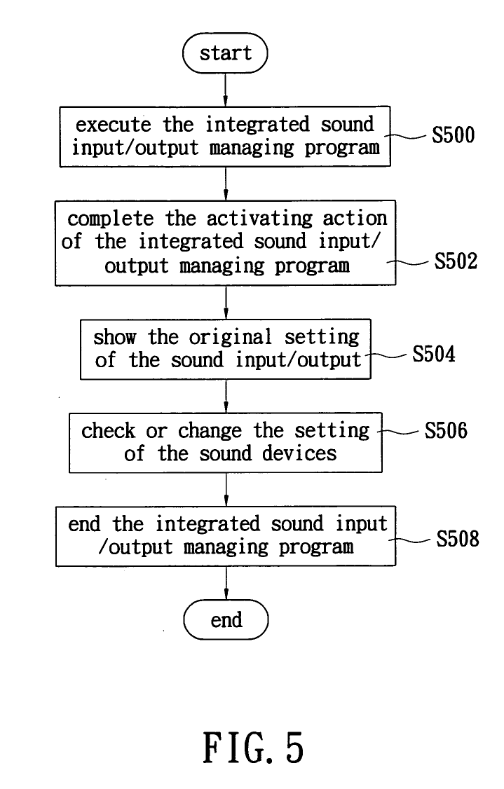

Reference is made to FIG. 5 together with FIG. 1. FIG. 5 is a flow chart of the third embodiment of a sound input/output managing method in accordance with the present invention. After the sound device 12, which has an identification key, is connected with the host computer 10, the host computer 10 is also connected electrically with any other sound devices. As shown in FIG. 5, the method of the present invention includes following steps. First, the integrated sound input/output managing program of the host computer 10 is activated (step S500). Then, the activating action of the integrated sound input/output managing program is completed (step S502). After that, the original setting of the host computer 10 about the sound input/output of at least a specific application program is shown (step S504). Subsequently, by using the display device 11, a user can check or change the setting about the sound input/output devices of other application programs and at least a specific application program (step S506). Finally, the user can terminate the integrated sound input/output managing program (step S510).

In the present invention, after the sound device, which has an identification key, is connected with the host computer 10, the integrated sound input/output managing program is activated to manage the operation of at least a sound device. Via a graphical interface, a user can choose the sound device of an application program that is active. Thus, the trouble and inconvenience caused by simultaneously using multiple application programs that needs to function with a sound device are resolved effectively.

To sum up, the present invention provides a novel system for managing a sound input/output and a method for the same that are hard to come by. It has utility, novelty and non-obviousness and completely fulfills the requirements of the patent application. Thus, this invention is applied according to U.S. patent law. Please examine this application carefully and give an allowance for this application to protect the inventors' right.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A system for managing a sound input/output, comprising:
a host computer having a central processing unit (CPU) used to process and control input/output signals and a peripheral managing unit connected electrically to the CPU, wherein the peripheral managing unit is used to manage the input/output signals of the CPU;
a sound device having an identification key, wherein the sound device has a sound processing unit used for conversion and compression of the input/output signals and an interface control unit connected electrically to the sound processing unit and the host computer, the interface control unit controlling the input/output signals transferred between the host computer and the sound device and having the identification key stored therein; and
a display device connected electrically to the host computer to show an operative condition of at least one of sound devices having a connection to the host computer;
wherein an integrated sound input/output managing program is used to manage an operation of at least one of the sound devices.

2. The system as claimed in claim 1, wherein the sound device having the identification key has a USB interface.

3. The system as claimed in claim 1, wherein the sound device having the identification key has an IEEE 1394 interface.

4. The system as claimed in claim 1, wherein the host computer has at least a built-in sound device.

5. The system as claimed in claim 1, comprising at least a sound device connected electrically to the host computer.

6. The system as claimed in claim 1, wherein the integrated sound input/output managing program is active only after being driven by the sound device having the identification key.

7. The system as claimed in claim 1, wherein the host computer is a computer system.

8. The system as claimed in claim 1, wherein the host computer further has a peripheral input device.

9. A sound device having an identification key, comprising:
a sound processing unit used for conversion and compression of input/output signals; and
an interface control unit connected electrically to the sound processing unit and a host computer, the interface control unit controlling the input/output signals transferred between the host computer and the sound device and having the identification key stored therein;
wherein an integrated sound input/output managing program is used to manage an operation of at least a sound device.

10. The system as claimed in claim 9, wherein the sound device having the identification key has a USB interface.

11. The system as claimed in claim 9, wherein the sound device having the identification key has an IEEE 1394 interface.

12. The system as claimed in claim 9, wherein the integrated sound input/output managing program is active only after being driven by the sound device having the identification key.

13. The system as claimed in claim 9, wherein the host computer is a computer system.

14. A method for managing a sound input/output, comprising:
connecting a sound device having an identification key with a host computer;
identifying the identification key of the sound device;
driving an integrated sound input/output managing program; and
using the integrated sound input/output managing program to control at least a sound device of the host computer.

15. The method as claimed in claim 14, wherein before or after the step of connecting the sound device having an identification key with a host computer is performed, the method further comprises:
installing the integrated sound input/output managing program onto the host computer.

16. The method as claimed in claim 14, wherein if identification of the identification key of the sound device succeeds, the next step is performed, and if not, all steps end.

17. The method as claimed in claim 14, wherein the step of using the integrated sound input/output managing program to control the sound device of the host computer further comprises:
executing the integrated sound input/output managing program installed on the host computer;
checking if an activating action of the integrated sound input/output managing program is completed;
loading a setting file and showing original sound input/output settings of the host computer and at least a specific application program;
selecting the specific application program's sound device; and
ending the integrated sound input/output managing program and store the setting file.

18. The method as claimed in claim 17, wherein in the step of checking if the activating action of the integrated sound input/output managing program is completed, if the activating action is completed, the next step is performed, and if not, the setting file is automatically produced, wherein after the host computer is set and the sound device of the specific application program is set, the produced setting file is loaded to show the original sound input/output settings of the host computer and the application program.

19. The method as claimed in claim 17, wherein the specific application program is a communication program, including an MSN program, a Skype program or a Yahoo program.

20. The method as claimed in claim 17, wherein the specific application program is a video playback program.

21. A method for managing a sound output, the method comprising steps as follows when a new sound device is connected electrically to a host computer:
executing an integrated sound input/output managing program installed on the host computer;
checking if an activating action of the integrated sound input/output managing program is completed;
loading a setting file and showing original sound input/output settings of the host computer and at least a specific application program;
selecting the specific application program's sound device; and
ending the integrated sound input/output managing program and store the setting file.

22. The method as claimed in claim 17, wherein in the step of checking if the activating action of the integrated sound input/output managing program is completed, if the activating action is completed, the next step is performed, and if not, the setting file is automatically produced, wherein after the host computer is set and the sound device of the specific application program is set, the produced setting file is loaded to show the original sound input/output settings of the host computer and the application program.

23. The method as claimed in claim 21, wherein the specific application program is a communication program, including an MSN program, a Skype program or a Yahoo program.

24. The method as claimed in claim 21, wherein the specific application program is a video playback program.

25. A method for managing a sound output, the method comprising steps as follows when no new sound device is connected electrically to a host computer:
executing an integrated sound input/output managing program installed on the host computer;
completing an activating action of the integrated sound input/output managing program;
selecting at least a specific application program's sound device; and
ending the integrated sound input/output managing program.

26. The method as claimed in claim 25, wherein the specific application program is a communication program, including an MSN program, a Skype program or a Yahoo program.

27. The method as claimed in claim 25, wherein the specific application program is a video playback program.
